(19) United States
(12) Patent Application Publication
(10) Pub. No.: US 2008/0034725 A1
(43) Pub. Date: Feb. 14, 2008

(54) Forage Cutter

(76) Inventor: Andre Pellerin, Saint-Adrien-De-Ham (CA)

Correspondence Address: GOUDREAU GAGE DUBUC, 2000 MCGILL COLLEGE, SUITE 2200, MONTREAL, QC, H3A 3H3, CA

(21) Appl. No.: 11/720,038

(22) PCT Filed: Nov. 24, 2005
(86) PCT No.: PCT/CA05/01784

§ 371 Date: May 23, 2007

Related U.S. Application Data
(60) Provisional application No. 60/630,662, filed on Nov. 26, 2004.

(30) Foreign Application Priority Data
Nov. 24, 2004 (CA) 2,488,608

(51) Int. Cl. A01D 75/08; A01F 29/04; B24B 3/46

(52) U.S. Cl. 56/250; 56/249

(57) ABSTRACT

Forage cutter (1) for cutting forage or similar material in an enclosure having a first and second series of vertical blades (14, 16) for cutting the forage, a conveyor (25) for directing the forage forwardly and cooperating with the blades (14, 16) to spin the forage in an opposite direction with respect to the direction of rotation of the blades (14, 16); and roller means (23) vertical spaced below the second series of blades (16) and above the conveyor (25), the roller means (23) being rotatable in the same direction as the blades (14, 16) for selectively directing a first part of the forage having longer strands against the blades (14, 16) and a second part of the forage having shorter strands out of the enclosure.

### FIELD OF THE INVENTION

The present invention relates to an apparatus for cutting forage, hay or the like.

### BACKGROUND OF THE INVENTION

Known in the art, there are several devices used to cut forage bales, such as for example: U.S. Pat. No. 3,612,127 (BENNO); U.S. Pat. No. 3,618,649 (BENNO); U.S. Pat. No. 4,909,139 (MONTANO); U.S. Pat. No. 5,017,399 (MONTANO); U.S. Pat. No. 5,099,755 (MONTANO); U.S. Pat. No. 5,367,932 (BERGMAN); and U.S. Pat. No. 5,217,174 (MARTIN). However, the blades of those devices that are used to cut the forage bales become prematurely damaged when coming in contact with rocks that are usually present therein. Furthermore, these devices become less efficient or even inoperable when fed with loose forage, especially when the forage is wet.

### SUMMARY OF THE INVENTION

According to the present invention, there is provided a forage cutter for cutting forage or similar material comprising:
an enclosure for receiving the forage;
a first and second series of vertical blades for cutting the forage at a front end of the enclosure, the blades being rotatable in a same direction about respective first and second horizontal axes and defining a portion where the blades overlap;
a conveyor for directing the forage forwardly in a linear direction from a back end of the enclosure towards the front end of the enclosure, the conveyor cooperating with the blades to spin the forage in an opposite direction with respect to the direction of rotation of the blades; and
roller means mounted at the front end of the enclosure and vertically spaced below the second series of blades and above the conveyor, the roller means being rotatable about a third horizontal axis in the same direction as the blades for selectively directing a first part of the forage having longer strands against the blades and a second part of the forage having shorter strands out of the enclosure, whereby, in operation, movement of the blades, conveyor and roller means continually spins the forage within the enclosure in an opposite direction with respect to a rotation of the blades.

Advantageously, during operation of the forage cutter as defined above, any rocks or extraneous solid materials that are present in the forage are less likely to go trough the blades, but rather will fall down by gravity onto the conveyor and exit the enclosure through a space defined between the conveyor and the roller means.

Another advantage of the forage cutter of the present invention is that it can shred many different shapes of forage bales that are wet or dry, and it can also efficiently shred loose forage that is wet or dry.

The invention as well as its numerous advantages will be better understood by reading of the following non-restrictive description of preferred embodiments made in reference to the appending drawings.

### BRIEF DESCRIPTION OF THE DRAWINGS

FIG. 1 is a perspective view of a forage cutter according to a preferred embodiment of the present invention.

FIG. 2 is a front elevation view of the forage cutter shown in FIG. 1.

FIG. 3 is another perspective view of the forage cutter shown in FIG. 1 with the side walls and other parts being removed.

FIG. 4 is a partial view of a portion of FIG. 3 indicated by circle A.

FIG. 5A is a front view of a blade provided with teeth according to a preferred embodiment of the present invention.

FIG. 5B is a partial view of a portion of FIG. 5A indicated by circle B.

FIG. 5C is a cross-sectional view of the blade of FIG. 5A along line C-C′.

FIG. 5D is a top view of the blade shown in FIG. 5B.

FIG. 6 is a perspective view of a tool for sharpening the blades of the forage cutter shown in FIG. 1, according to a preferred embodiment.

FIGS. 7A to 7F are perspective views of the forage cutter of FIG. 1 during operation showing the trajectory of a rock present in the forage.

### DETAILED DESCRIPTION OF THE INVENTION

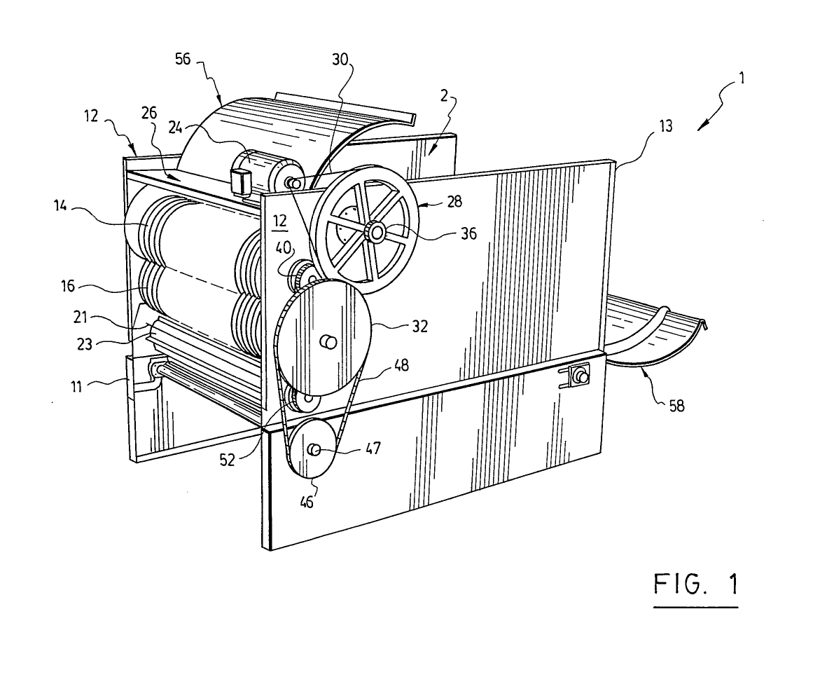

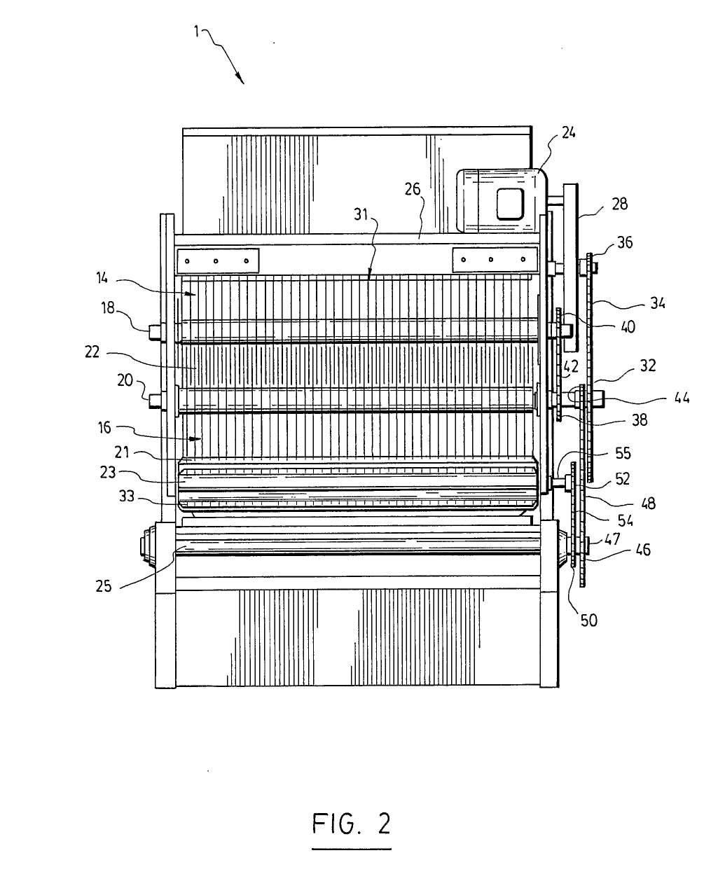

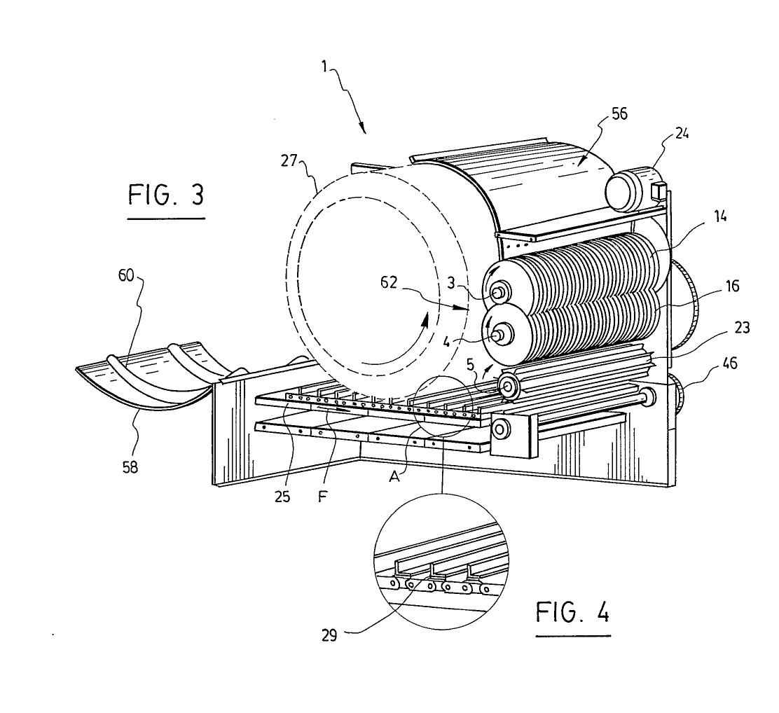

Referring to FIGS. 1 to 4, there is shown a forage cutter 1 according to a preferred embodiment of the present invention. The forage cutter 1 has a pair of opposite side walls 12 that are spaced from each other at a predetermined distance to define an enclosure 2. The forage cutter 1 also has a front end 11 where cut forage comes out and a back end 13 where forage is fed in. The side walls 12 support an upper and lower series of vertical blades 14, 16. The blades 14, 16 are mounted on corresponding upper and lower axles 18, 20 that extend perpendicularly with respect to the side walls 12 and adjacent to the front end 11 of the forage cutter 1. The upper and lower axles 18, 20 define respective first and second horizontal axes 3, 4. The cutting blades 14, 16 are mounted so that a portion 22 thereof overlaps with each other, as is best shown in FIG. 2. The blades 14, 16 are preferably circular blades but other types of blades may be used for the same purpose. In the example illustrated in FIG. 2, there are shown about forty upper blades and about the same number of lower blades. It should be noted however that the exact number of blades may vary according to the particular design requirements such as size and power availability. The blades 14, 16 are rotated in the same direction as shown for example by the arrows in FIG. 3. The lateral spacing between each blade has an effect on the length of the cut forage. Indeed, the smaller the lateral distance between the blades, the smaller is the length of the strands of forage that are cut.

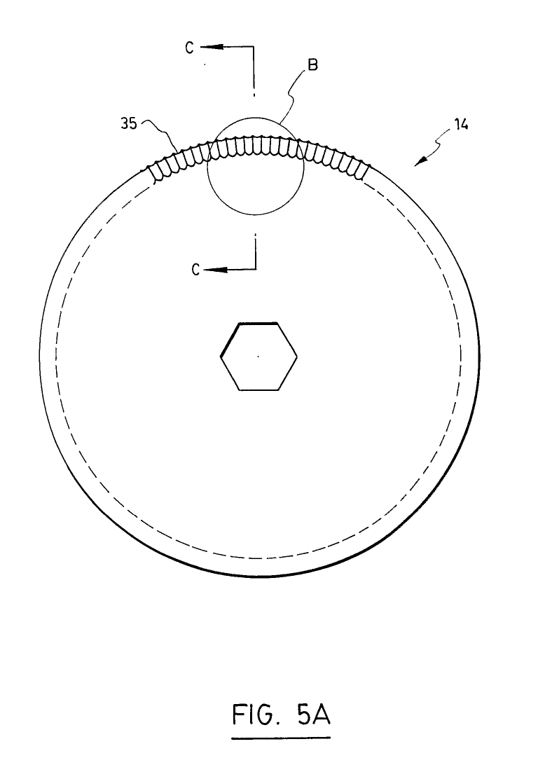

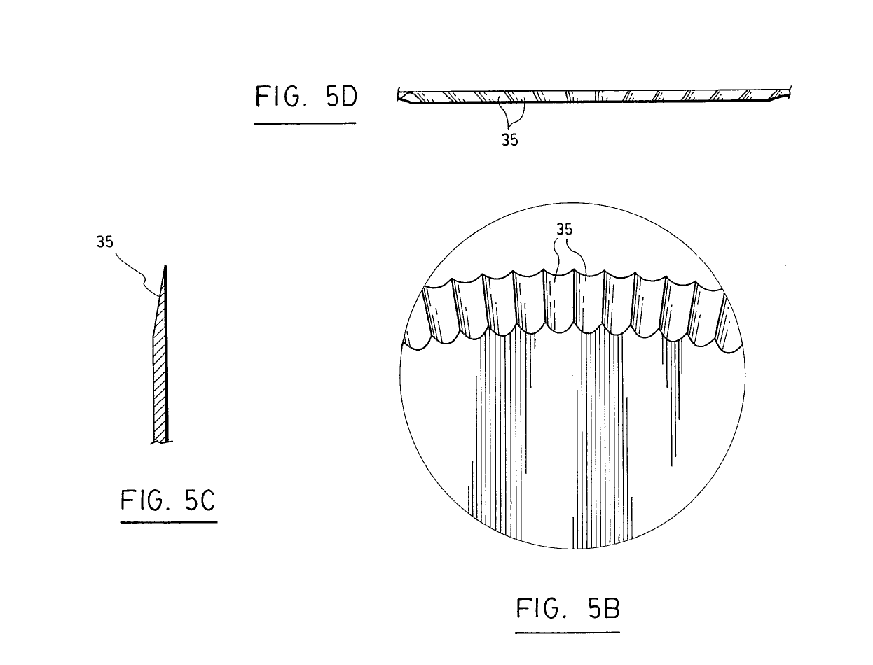

Referring to FIGS. 5A, 5B, 5C and 5D, the blades 14, 16 are preferably provided with specially shaped teeth 35 on one side thereof for improving the forage cutting. Referring to FIG. 5C, each tooth 35 is formed by a recessed cavity in the metal of the corresponding blade 14, 16. The recessed cavity has a depth of about 10 degrees with respect to the blade. The back side of the teeth 35 also has slanted portion of about 10 degrees with respect to the blade. The upper and lower blades 14, 16 are positioned so that each adjacent pair of blades alternates between two facing sides provided with teeth and two facing sides that have no teeth.

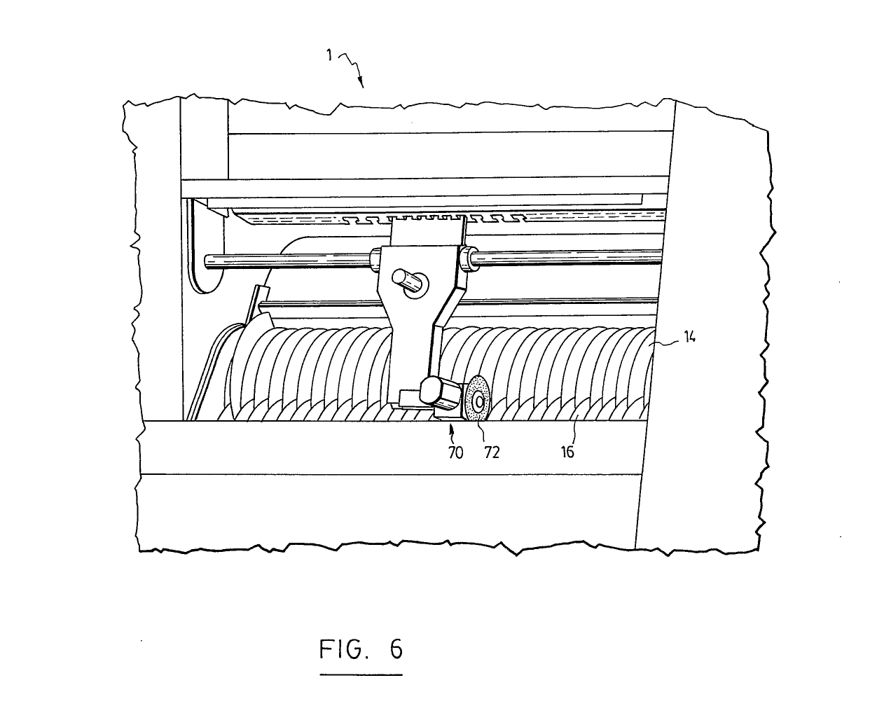

Referring to FIG. 6, there is shown a tool 70 for sharpening the teeth 35 of blades 14, 16 of the forage cutter 1, according to a preferred embodiment of the present invention. This tool 70 may be added separately to the forage cutter 1. The tool 70 includes a sharpening wheel 72 having a shape that is complementary to the shape of the teeth 35 of the blades 14, 16. The tool 70 may be manually operated or it can be placed at the end of a driving device that moves it automatically across the blades 14, 16. In operation, the sharpening wheel 72 of the tool 70 is positioned between two blades and is turned at about 5000 rpm while the blades 14, 16 rotate at about 50 to 60 rpm. The same process may be repeated for each pair of blades until all the blades are sharpened. This type of tool 70 is easy and advantageous to use because of the configuration of the blades 14, 16, which are all equally spaced from each other. There is therefore no need to remove the blades 14, 16 for sharpening thereof. Of course, this tool 70 is to be modified depending on the type of blade that is used, as those skilled in the art will understand.

A longitudinal adjustable plate 31 is positioned on top of the upper blades 14 to prevent non-cut forage to come out from between a top plate 26 and the upper blade 14. The adjustable plate 31 may be re-positioned lower when the upper blades 14 shrink because of usage and re-sharpening of the blades 14.

The forage cutter 1 also includes a conveyor 25 extending at the bottom of the enclosure 2. As shown for example in FIG. 3, the conveyor 25 is preferably an endless chain conveyor that moves a forage bale 27 forward as shown by arrow F towards the blades 14, 16. It should be noted that the conveyor 25 is not shown in its entirety in order to simplify the drawing. The conveyor 25 may be provided with perpendicularly extending edges 29, as best shown for example in FIG. 4, to aid in the forward pushing movement of the forage bale 27. It should also be noted that the forage bale 27 can be replaced with any type of forage of any shape or even loose forage that is either dry or humid. Other material to be cut may also be used instead of forage, such as hay, cardboard, or any other similar material that can to be grinded down by the blades 14, 16.

The forage cutter 1 also includes a roller 23 located below the lower blades 16 near the front end 11 of the forage cutter 1 and above the conveyor 25. The roller 23 extends perpendicularly with respect to the two side walls 12 and is rotatable about a third horizontal axis 5 in the same direction as the blades 14, 16. The roller 23 is preferably a cylindrical tube provided with several longitudinal projecting edges 21 made of a resilient material, such as rubber or plastic. Each of the edges 21 may be provided with grooves 33 that are sized to conform to the lower blades 16. The purpose of the roller 23 is to selectively direct a first part of the forage having longer strands against the blades 14, 16 and a second part of the forage having shorter strands out of the enclosure 2. The roller 23 separates longer strands of forage that tend to be directed upwards towards the blades, whereas shorter strands of forage tend to continue on the conveyor 25.

Alternatively, the roller 23 may be replaced with a series of rotating blades similar to the upper and lower blades 14, 16. Any other means for achieving the same purpose as the roller 23 may be used as will be understood by those skilled in the art.

The blades 14, 16, the roller 23 and the conveyor 25 may be rotated by means of a single motor 24 that is preferably mounted on the top plate 26 of the forage cutter 1. The motor 24 is preferably an electric motor, but other types of motor devices may be used as those skilled in the art will understand. The motor 24 preferably drives a primary driving wheel 28 via a belt 30. The driving wheel 28 has a driving sprocket wheel 36 that is mounted on the axle of the driving wheel 28 for driving a driven sprocket wheel 32 that is mounted on the lower axle 20, via a chain belt 34, and thus rotating the lower blades 16. The lower axle 20 has a second sprocket wheel 38 that mounted thereon and is connected to an upper sprocket wheel 40 that is mounted on the upper axle 18 via a belt chain 42, thereby rotating the upper blades 14. The lower axle 20 has a third sprocket wheel 44 that drives a sprocket wheel 46 via a chain belt 48. The sprocket wheel 46 is connected to a driven axle 47 of the conveyor 25. The driven axle 47 has a sprocket wheel 50 that is connected to a sprocket wheel 52 mounted on a driven axle 55 of the roller 23 via a chain belt 54. Of course, those skilled in the art will understand that other mechanisms may be used to drive the blades 14, 16, the roller 23 and conveyor 25. For instance, another separate motor (not shown) may be used to drive the conveyor independently. This may be particularly useful in order to better control the debit flow of forage that is cut.

The forage cutter 1 also includes an upper compaction wall 56 for enclosing the forage bale 27 or loose forage. The upper compaction wall 56 is preferably pivotally mounted on the top plate 26 of the forage cutter 1. A lower curved wall 58 is pivotally mounted near the back end 13 of the forage cutter 1 and may be used to hold another forage bale. The upper compaction wall 56 is preferably curved to conform to the shape of the forage bale 27. The lower wall 58 may be provided with longitudinal protuberances 60 for allowing the user to remove any cords on the forage bale 27. When the upper wall 56 is pivoted inwardly, it forms along with the side walls 12, a compaction chamber 62 where the forage bale 27 has been loaded.

In operation, it should be noted that the blades 14, 16 rotate in the same direction but faster that both the roller 23 and conveyor 25. The user introduces the forage bale 27 or loose forage through the back end 13 of the forage cutter 1 and into the compaction chamber 62 by opening the compaction wall 56. The forage bale 27 is then pushed forward by means of the conveyor 25 and starts rotating in the direction shown by the arrow in FIG. 3, which is in the opposite direction of rotation of the blades 14, 16. The forage bale 27 is then pushed toward the blades 14, 16 that cut the forage and the roller 23 separates longer strands of forage that tend to be directed upwards towards the blades 14, 16, whereas shorter strands of forage that were previously cut by the blades 14, 16 tend to fall on the conveyor 25 and be guided by the conveyor 25 out of the front end 11 of the forage cutter 1. The side walls 12 and compaction wall 56 also aid in maintaining a pressure on the forage bale 27 or loose forage against the blades 14, 16.

In the case that only loose forage is introduced into the forage cutter 1, the movement of the conveyor 25, roller 23, and blades 14, 16 and the constraint of the side walls 12 and compaction wall 56 will be such that a bale will be formed in the enclosure 2.

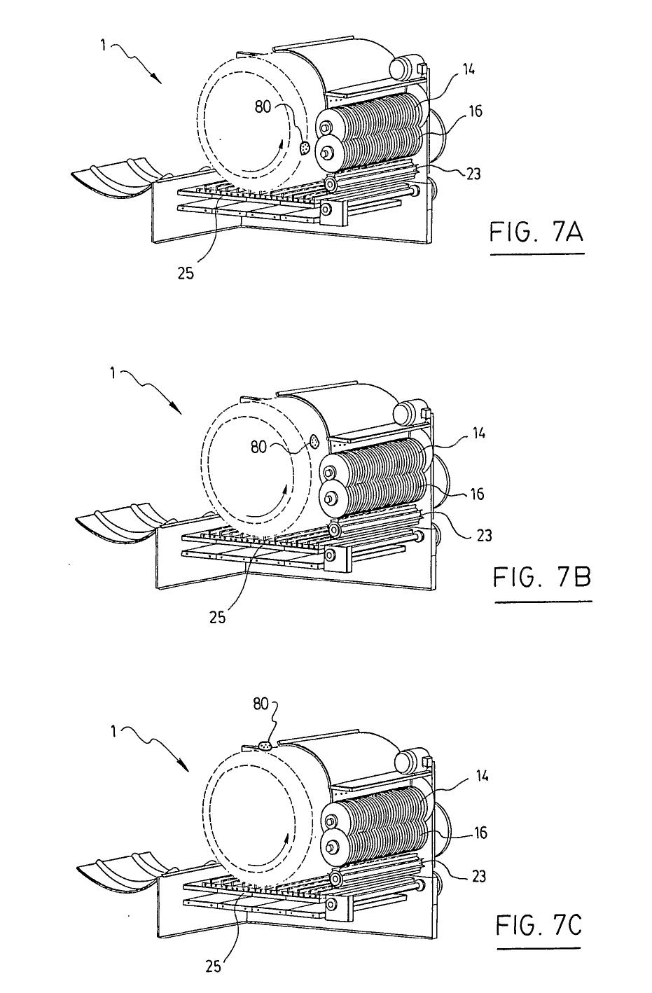

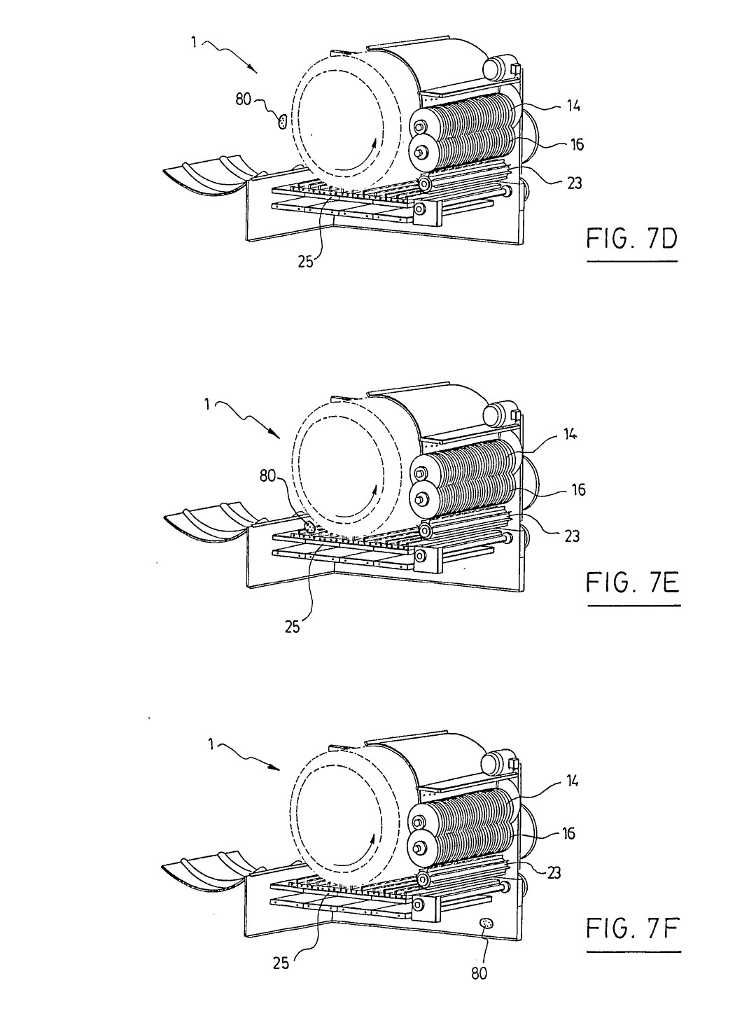

Referring to FIGS. 7A to 7F, there is shown the forage cutter 1 during operation and showing the trajectory of a rock 80 that is present in the forage. As mentioned above, one of the major problems of the forage cutters of the prior art is that the design and position of the blades cause the blades to become damaged prematurely. Indeed, as the forage is cut and passes through the blades, so do rocks and any extraneous solid materials. However, with the present forage cutter 1, the damage to the blades by rocks or extraneous solid materials is greatly diminished. As shown in FIGS. 7A to 7C, a rock 80 comes into contact with the blades 14, 16 but the impact is minimal as the rock is pushed backwards and away from the blades 14, 16. As shown in FIGS. 7D to 7F, the rock 80 falls down onto the conveyor 25 by gravity and continues its path along the conveyor 25 and comes out the enclosure 2 in a space defined between the conveyor 25 and the roller 23 without ever coming back into contact with the blades 14, 16.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

1. A forage cutter (1) for cutting forage or similar material comprising:
an enclosure (2) for receiving the forage;
a first and second series of vertical blades (14, 16) for cutting the forage at a front end (11) of the enclosure (2), the blades (14, 16) being rotatable in a same direction about respective first and second horizontal axes (3,4) and defining a portion (22) where the blades (14, 16) overlap;
a conveyor (25) for directing the forage forwardly in a linear direction (F) from a back end (13) of the enclosure (2) towards the front end (11) of the enclosure (2), the conveyor cooperating with the blades (14, 16) to spin the forage in an opposite direction with respect to the direction of rotation of the blades (14, 16); and
roller means (23) mounted at the front end (11) of the enclosure (2) and vertically spaced below the second series of blades (16) and above the conveyor (25), the roller means (23) being rotatable about a third horizontal axis (5) in the same direction as the blades (14, 16) for selectively directing a first part of the forage having longer strands against the blades (14, 16) and a second part of the forage having shorter strands out of the enclosure, whereby, in operation, movement of the blades (14, 16), conveyor (25) and roller means (23) continually spins the forage within the enclosure (2) in an opposite direction with respect to a rotation of the blades (14, 16).

2. The forage cutter (1) according to claim 1, wherein the roller means (23) include a roller (23) having a cylindrical tube provided with longitudinal projecting edges (21).

3. The forage cutter (1) according to claim 1, wherein each longitudinal projecting edge (21) is made of a resilient material and is provided with a series of grooves (33) corresponding to the second series of blades (16).

4. The forage cutter (1) according to claim 3, wherein the resilient material includes rubber.

5. The forage cutter (1) according to claim 3, wherein the resilient material includes a plastic material.

6. The forage cutter (1) according to claim 1, wherein the first and second series of blades (14, 16) are provided with teeth (35).

7. The forage cutter (1) according to claim 6, wherein each of the teeth (35) includes a recessed cavity on a front side of the corresponding blade (14, 16) and a slanted portion on a back side of the corresponding blade (14, 16).

8. The forage cutter (1) according to claim 7, wherein the recessed cavity has a depth of about 10 degrees with respect to the corresponding blade (14, 16) and the slanted portion has a slant of 10 degrees with respect of the corresponding blade (14, 16).

9. The forage cutter (1) according to claim 7, further comprising a tool (70) for sharpening the teeth (35) of the blades (14, 16), the tool (70) including a sharpening wheel (72) that is complementary in shape to a shape of the teeth (35), the tool (70) being movable along an axis that is parallel to the first and second horizontal axes (3, 4) of the blades (14, 16).

10. The forage cutter (1) according to claim 1, wherein the conveyor (25) is provided with perpendicularly extending edges (29) for assisting in directing forward the forage located inside the enclosure.
